(19) United States
(12) Patent Application Publication
(10) Pub. No.: US 2003/0026103 A1
(43) Pub. Date: Feb. 6, 2003

(54) Vehicle-mountable light assembly having auxiliary functional unit

(75) Inventors: Dian H. Reese, Holland, MI (US); Rick A. Anderson, Grand Haven, MI (US); Brant J. Potter, Holland, MI (US); Scott A. Hansen, Holland, MI (US); Jason M. Denbow, South Haven, MI (US)

Correspondence Address: Steven C. Becker, FOLEY & LARDNER, Firstar Center, 777 East Wisconsin Avenue, Milwaukee, WI, 53202-5367, US

(73) Assignee: Johnson Controls Technology Company

(21) Appl. No.: 09/918,673

(22) Filed: Jul. 31, 2001

(51) Int. Cl. B60Q 3/00

(52) U.S. Cl. 362/486; 362/183; 362/191

(57) ABSTRACT

A vehicle-mountable light assembly comprises a body, a power source, a light source, and an auxiliary functional unit. The body is configured to be mounted to a vehicle interior. The light source is coupled to the power source and the body and is configured to provide sustained light. The auxiliary functional unit is a non-light source unit which is coupled to the body.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present specification relates to vehicle-mountable light assemblies. More specifically, the present specification relates to vehicle-mountable light assemblies having improved functionality.

### BACKGROUND OF THE INVENTION

In the field of automotive electronics, various lighting systems are currently in use. Standard lighting fixtures include dome lights, door-mounted convenience lights, and map lights. These lighting fixtures are either fixed in position or movable, such as by sliding or rotating, to selectively provide light to various spaces in the vicinity of the fixture.

More recently, lighting systems which are removable from the vehicle have been proposed. For example, one system includes a side view mirror with a detachable flashlight. When removed from the mirror, the light provides an optional flashlight accessory. In another system, a combination courtesy light and detachable flashlight assembly is provided to permit the operator of a vehicle to detach the flashlight from a flush-mounted receptacle. The flashlight operates from rechargeable batteries charged by a power supply when the flashlight is inserted in the receptacle.

Consumers are increasingly depending on their vehicles for improved convenience and emergency features. For example, some vehicles provide entertainment systems, such as video cassette players, in a rear portion of the vehicle for the viewing enjoyment of back seat passengers. Other vehicles provide wireless emergency services at the touch of a button, whereupon the vehicle location and a distress message are sent to a remote operator who can provide assistance.

As consumers increasingly use their vehicles for travel, entertainment, commuting, and other uses, improved convenience and emergency features are in demand. Accordingly, there is a need for a vehicle-mountable light assembly having improved functionality. Further, there is a need for a portable light assembly having an auxiliary functional unit for improved functionality. Further still, there is a need for a vehicle-mountable light assembly that integrates multiple functional units into one carryable device. Further still, there is a need for a light assembly suitable for use within the vehicle as an interior light source and for use external to the vehicle as a portable light source, wherein the light assembly has additional functionality, such as convenience or emergency features, integrated therein.

The teachings hereinbelow extend to those embodiments which fall within the scope of the appended claims, regardless of whether they accomplish one or more of the above-mentioned needs.

### SUMMARY OF THE INVENTION

According to one exemplary embodiment, a vehicle-mountable light assembly comprises a body, a power source, a light source, and an auxiliary functional unit. The body is configured to be mounted to a vehicle interior element. The light source is coupled to the power source and the body and is configured to provide sustained light. The auxiliary functional unit is a non-light source unit.

According to another exemplary embodiment, a multi-functional light source for a vehicle comprises a body, a power source, a light source, and a means for providing an auxiliary function. The body is configured to be mounted to a vehicle interior. The body comprises an interface circuit configured to receive power from the vehicle. The power source is coupled to the interface circuit and is configured to receive the vehicle power. The light source is coupled to the power source.

According to yet another exemplary embodiment, a flashlight comprises a body, a light-emitting diode, and a mounting arrangement. The mounting arrangement is configured to couple the light-emitting diode to the body. The mounting arrangement is configured to position the light-emitting diode in a first position to direct light in a first direction and to position the light-emitting diode in a second direction to direct light in a second direction different than the first direction.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a perspective view of a vehicle-mountable light assembly having a functional unit, according to an exemplary embodiment;

FIG. 2 is a schematic diagram of a vehicle-mountable light assembly, according to an exemplary embodiment;

FIG. 3 is a perspective view of the light assembly of FIG. 1 mounted to an interior side wall of the vehicle, according to an exemplary embodiment;

FIG. 4 is a perspective view of the light assembly of FIG. 1 mounted to a rear hatch door, according to an exemplary embodiment;

FIG. 5 is a partial cross-sectional view of a power interface and a corresponding interface circuit coupled to a vehicle interior element, according to an exemplary embodiment;

FIG. 6 is a partial cross-sectional view of a wall-mountable power interface and a household power source, according to an exemplary embodiment;

FIG. 7 is a perspective view of a vehicle-mountable light assembly in a first position, according to an exemplary embodiment;

FIG. 8 is a perspective view of the vehicle-mountable light assembly of FIG. 7 in a second position, according to an exemplary embodiment;

FIG. 9 is a partial cross-sectional view illustrating a light source mounting arrangement, according to an exemplary embodiment;

FIG. 10 is a perspective view of a vehicle-mountable light assembly having a taser functional unit in an open position, according to an exemplary embodiment;

FIG. 11 is a perspective view of the light assembly of FIG. 10 in a closed position, according to an exemplary embodiment;

FIG. 12 is a partial perspective view of a rear portion of a vehicle-mountable light assembly having a taser functional unit, according to an exemplary embodiment; and

FIG. 13 is a perspective view of the vehicle-mountable light assembly of FIG. 12, according to an exemplary embodiment.

### DETAILED DESCRIPTION OF EXEMPLARY EMBODIMENTS

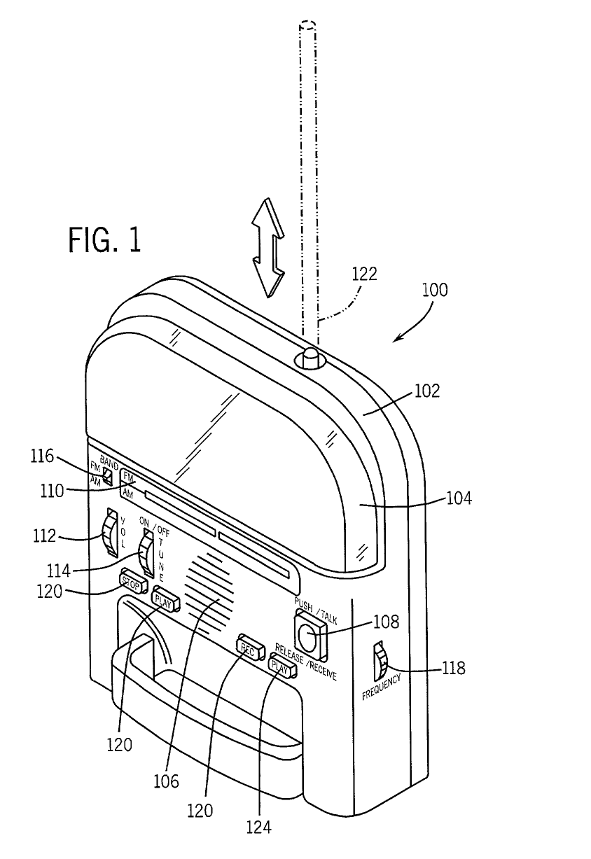

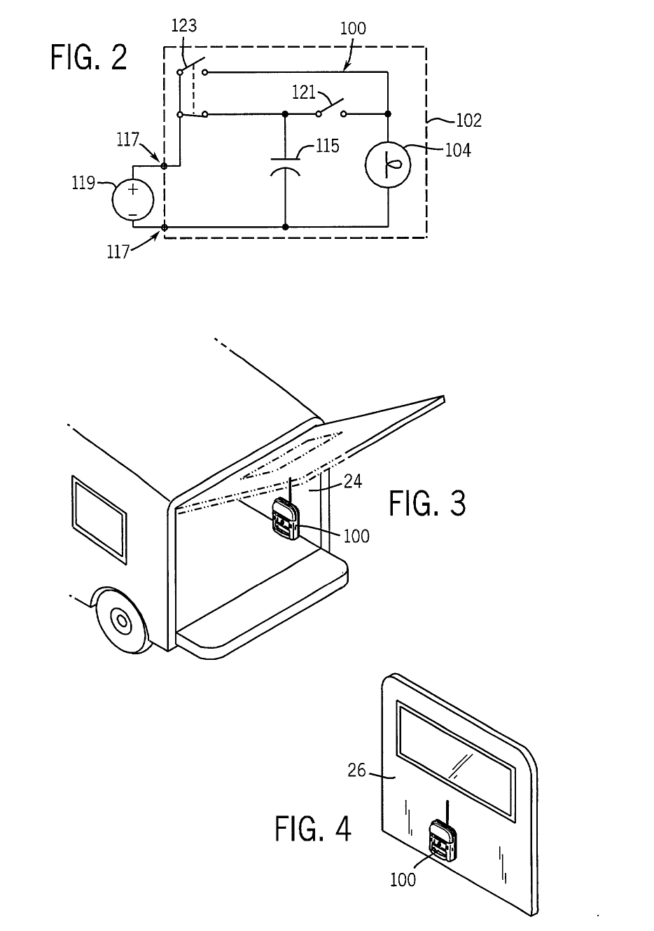

Referring first to FIG. 1, a vehicle-mountable light assembly 100 is illustrated according to an exemplary embodiment. Light assembly 100 includes a body 102, a power source (not shown), and a light source 104. Body 102 comprises plastic, polymer, metal, non-metal materials, or other suitable body materials. Body 102 is configured for mounting to a vehicle interior element, as will be described hereinbelow with reference to FIGS. 3-5 in exemplary fashion. The power source and light source 104 will be described hereinbelow with reference to FIG. 2 in exemplary fashion.

Light assembly 100 provides sustained light via light source 104. Light assembly 100 is of sufficient size to be portable, such that light assembly 100 can be carried by a user away from the vehicle to which it is mounted. In this manner, light assembly 100 can be used as a portable light source such as a flashlight, torch light, emergency light, etc.

According to one advantageous aspect, light assembly 100 further includes one or more auxiliary functional units. Light assembly 100 has a size slightly larger than a conventional small flashlight, in this exemplary embodiment. For example, a lantern size, having more than 12 cubic inches in volume is preferred. Accordingly, space beyond that necessary for lighting circuitry is available within body 102 to provide at least one auxiliary functional unit.

Auxiliary functional units include any non-light source functional unit which provides an added feature of convenience or emergency to a user which is unrelated to the function of providing light. Auxiliary functional units include electrically-powered functional units and mechanical functional units. Electrically-powered functional units include those functional units that require electrical power to perform at least one function. For example, electrical functional units include both emergency and convenience functional units. Convenience functional units include those functional units that provide service or options to a user.

One exemplary convenience functional unit is a two-way radio utilizing two-way radio or “walkie talkie” technology or a Family Radio System (FRS) to allow a person using light assembly 10 to communicate with a remote two-way radio. Such a remote two-way radio may be vehicle-mounted such as, in the instrument panel or otherwise near the driver of the vehicle, or may also be a portable two-way radio, such as a light assembly similar to light assembly 100. Exemplary uses include running errands, dropping off and picking up multiple passengers, going camping or hiking, etc. Thus, light assembly 100 includes a speaker/audio receiver 106, and a talk input device 108 to facilitate communication in a conventional two-way radio format. Additional configurations are contemplated.

Convenience functional units may also include a radio, as illustrated at radio 110, having a volume adjust input device 112, a tune adjust input device 114, a band select input device 116 and a frequency select input device 118. Convenience functional units can also include a cassette player, a CD player, a DVD player, etc. Standard stop, play, and record input devices 120 are provided for these functionalities. Further, a retractable antenna 122 is provided for either or both of two-way radio functionality and AM/FM radio functionality.

Convenience functional units further may include a charger and docking station for a wireless phone or personal digital assistant (PDA), a clock, a compass, or an audio recording/playback device, such as, the TravelNote Digital Voice Recorder, manufactured by Johnson Controls, Inc., Plymouth, Mich.

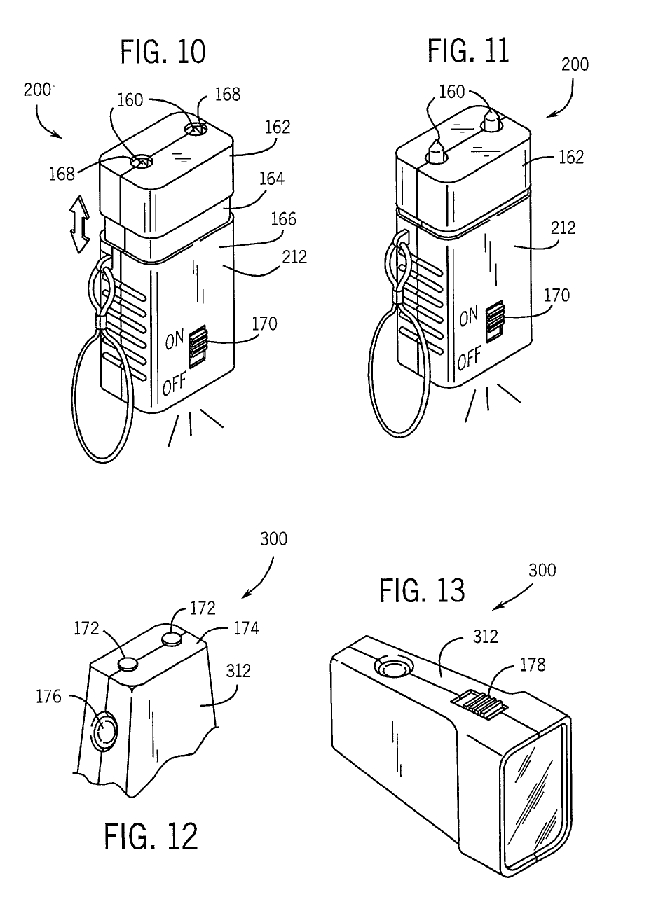

Electrically-powered auxiliary functional units may also include emergency functional units, such as, emergency weather radio. An emergency functional unit may also include a voice-recorded spare tire changing instruction, wherein voice instructions are recorded in a digital or magnetic medium within body 102, the instructions being provided via speaker 106 in response to actuation of a “flat tire” input device 124. Emergency functional units may also include graphical or visual display of emergency instructions. Emergency functional units may also include a tracer or locator circuit configured to direct a person back to the vehicle or, alternatively, to direct people in the vehicle to light assembly 100. One exemplary technology to implement this may include a global positioning system (GPS) antenna and receiver mounted in each of light assembly 100 and the vehicle and further including a wireless transmitter to provide geographic position information between light assembly 100 and the vehicle. Light assembly 100 may further include audible instructions or a visual display to direct the user to the vehicle. An intelligent mobile unit with integrated GPS, such as, the Cross Check GSM product manufactured by Trimble Navigation Limited, Sunnyvale, Calif., may be used. A further emergency functional unit may include a taser as discussed hereinbelow with reference to FIGS. 10-13.

Auxiliary functional units can also include mechanical or non-electrical functional units, such as a bin for holding items. Mechanical functional units can also include a panel coupled to body 102 which includes emergency instructions (e.g., for emergency repair, operational instructions, weather emergencies, changing a spare tire, etc.) which may be provided in one or multiple languages.

The recitation hereinabove of the various auxiliary functional units does not preclude the inclusion of additional functional units. Light assembly 100 thus provides improved functionality and convenience for a user by providing both a light source and at least one auxiliary, non-light, functional unit in a vehicle-mountable assembly.

As illustrated in FIG. 1, it is particularly advantageous to combine a plurality of auxiliary functional units with a light source in light assembly 100 to provide further convenience or emergency functions. For example, having a plurality of auxiliary functional units allows for the combination of both electrical and mechanical auxiliary functional units.

Referring now to FIG. 2, a schematic diagram of light assembly 100 is illustrated. Light assembly 100 is preferably of sufficient size and weight to be carried by a person in a portable manner. Advantageously, light assembly 100 may be a rechargeable flashlight.

Light assembly 100 comprises body 102 which encases light source 104 and a power source, such as, a capacitor 115. In the case of an electrical auxiliary functional unit, said unit may be coupled in series or in parallel with capacitor 115, and power provided thereto in a manner similar to the manner in which power is provided to light source 104, as described hereinbelow. Alternatively, light source 104 and/or capacitor 115 may be partially or wholly disposed outside body 102. The power source may alternatively include batteries, rechargeable batteries, or other power sources, such as solar cells. Light source 104 includes one or more light-emitting diodes (LEDs) in this exemplary embodiment, but may alternatively include a fluorescent or incandescent light bulb or other light-emitting source. LED 104 may be an amber or white diode and can be packaged in groups of 2, 4, 8, etc. to house the brightness or adjust between multiple intensity levels. An LED is preferable to a light bulb in this embodiment because an LED draws much less current than a light bulb. For example, a typical LED having a voltage of 2.5 Volts (V) draws 20 milliAmperes (mA) of current. A suitable low-current light bulb has a voltage of 12 V, and draws 500 mA. In an embodiment wherein a light bulb is used, the light bulb will be a low-current light bulb, drawing approximately 900 mA or less. Use of low-ampere light sources provides a longer flashlight life for one full charge of capacitor 115. Further, multiple LEDs, light bulbs, and LEDs of different colors and intensities may be used.

According to one advantageous aspect of this exemplary embodiment, capacitor 115 is configured to provide power to light source 104. Accordingly, capacitor 115 is a large capacitor, having a Farad (F) rating of at least 10 F. Alternative embodiments may use super capacitors or ultra capacitors having Farad ratings of at least 10 F, at least 50 F, or more. Such capacitors typically have the physical size of a rechargeable battery, but provide advantageous features over a conventional rechargeable battery. In various alternative embodiments, the size and construction of capacitor 115 can be selected based on the characteristics of light source 104 to provide a suitably sustained light source. A sustained light source includes any duration of light suitable for a standard flashlight use, and excluding transient light sources on the order of less than 1 second. For example, a sustained light source preferably provides light for at least several seconds and preferably many minutes or even hours. As capacitor technology and light source technology improve, a capacitor-based light source can provide a sustained light source of many hours. An exemplary capacitor suitable for use herein is a PC10 ultra capacitor, manufactured by Powercache, San Diego, Calif. Another exemplary capacitor suitable for use in this exemplary embodiment is a Power Stor Aerogel Capacitor B Series having a capacitance value between 1 F and 50 F, manufactured by Cooper Electronic Technologies, Boynton Beach, Fla. In alternative embodiments, several capacitors may be provided in series to provide additional voltage for certain light sources.

Light assembly 100 further includes a power interface 117 configured to be coupled to a power source external to body 102 and to provide power to capacitor 115 or to another power source, such as a rechargeable battery. In this exemplary embodiment, power interface 117 includes electrical contacts coupled to body 102 which provide an electrical interface between an external power source 119 and light source 104 and capacitor 115. Power interface 117 may include only two electrical contacts, or may include additional circuit elements to provide signal conditioning, such as, AC to DC power conversion, voltage splitting, current limiting, high frequency or high power filtering, etc. External power source 119 may be any type of external power source, such as, a battery, a power circuit, a power generator, a wall-mounted power outlet, an automobile power supply, such as a vehicle battery, or other power sources. Light source 104 may be powered directly from power source 119 or may be powered from capacitor 115. Light source 104 may be powered while capacitor 115 is being charged from power source 119, or light source 104 may be disabled during charging of capacitor 115.

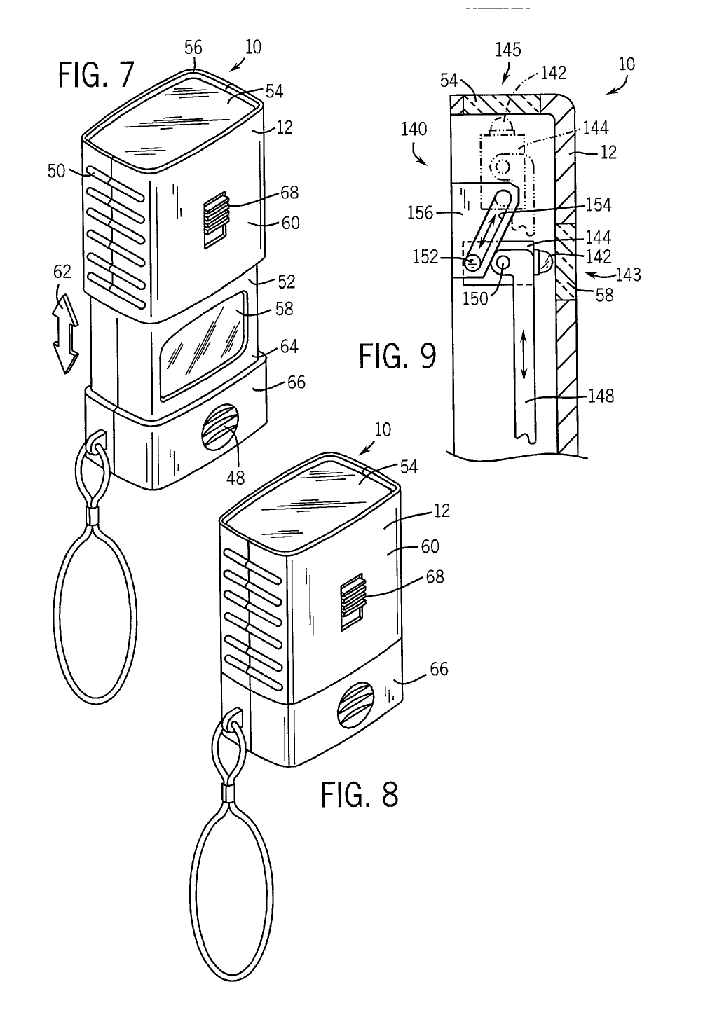

Light assembly 100 may further include a switch 121, such as a simple contact switch, an operator-actuatable switch, etc., to enable and disable providing power from capacitor 115 to light source 104. Additional exemplary embodiments of switch 121 are described hereinbelow with reference to FIGS. 7 and 8.

Rechargeable light 10 may further be configured to include a switch 23 to enable the operation of a courtesy light. A courtesy light is a light operable in response to the opening or closing of a door on a vehicle or in response to a button press on a remote keyless entry (RKE) device. As shown in FIG. 1, switch 23 is shown in a courtesy light OFF position. When switched to a courtesy light ON position, power is provided from external power source 20 to light source 14 in response to a door on a vehicle opening (wherein the door may be a passenger door, lift-gate, glove box, etc.), and wherein external power source 20 provides no power to light source 14 when the vehicle door is closed. Thus, switches 22 and 23 may be combined into a single three-position switch, having an OFF position, a DOOR position (in which the courtesy light function is active) and an ON position. (See, for example, FIG. 6).

In operation, capacitor 115 provides power to light source 104 (and any electrical auxiliary function unit) in a portable light source suitable for use by a person in a variety of lighting situations. The user may actuate switch 121 to enable and disable light source 104. Further, capacitor 115 may be powered from an external power source 119 to provide the advantage of recharging capacitor 115 in an easy and efficient manner. While the power source may include either a capacitor or rechargeable batteries, the use of a capacitor provides several advantages. Capacitor 115 will have a greater number of charge cycles and a slower discharge time when not in use than a standard NiCad rechargeable battery, is operable in a greater range of temperatures than a NiCad battery, and has a longer life span (both in number of recharge cycles and in years of use) than a typical NiCad battery. Further, capacitor 115 charges quickly, for example, on the order of minutes or an hour, while NiCads can take as long as 17 hours or longer to charge. Further, when used in an automobile, light assembly 100 may go unused for extended periods, during which time a rechargeable battery may no longer be functional. Advantageously, capacitor 115 will be charged and ready for operation even after many years.

Referring now to FIG. 3 and FIG. 4, a further advantageous aspect of light assembly 100 is illustrated. In this exemplary embodiment, light assembly 100 is configured to be coupled to a vehicle interior element, such as, a side wall 24, a door 26 (e.g., a side door, a lift-gate, etc.), a glove box, an instrument panel, a vehicle seat, the floor, the trunk, under a seat, or any other mounting location within the interior of a vehicle. The vehicle interior element may be a cargo space (i.e., any space rearward of the front seats suitable for holding cargo). A suitable coupling device is provided on either or both of the vehicle interior element 24, 26 and light assembly 100, which may include an electrical and/or mechanical coupling device. According to one exemplary embodiment, a detent mechanism may be provided that allows an operator to slide a connecting element on light assembly 100 into a mating connecting element on the vehicle interior element 24, 26, wherein the detent mechanism locks light assembly 100 into place. According to a further advantageous embodiment, such a coupling device may further include an electrical coupling arrangement wherein light assembly 100 receives power at power interface 117 from a second power interface within the vehicle interior element 24, 26. Further still, a separate courtesy light power line may be provided in addition to vehicle power and ground.

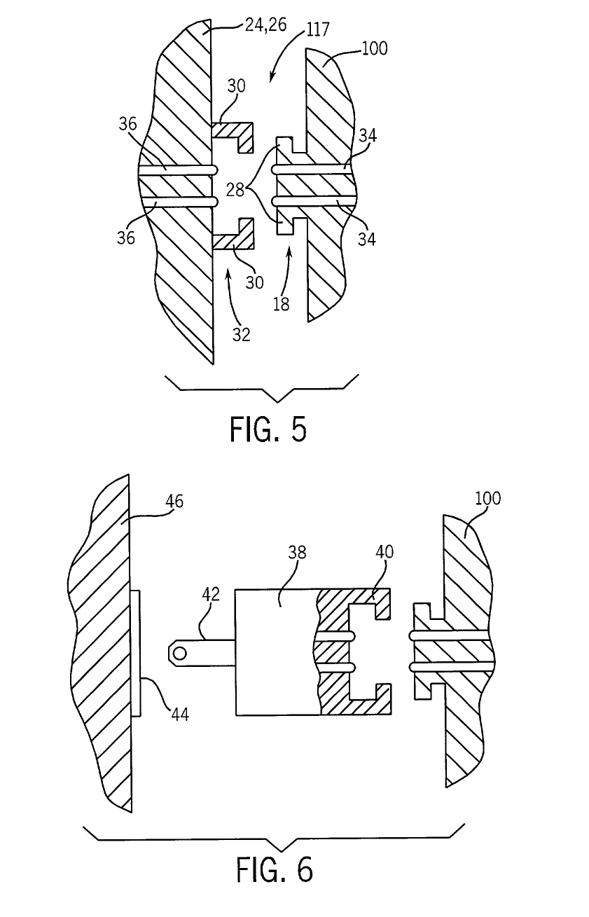

Referring now to FIG. 5, an exemplary coupling device for coupling light assembly 100 to vehicle interior element 24, 26 is illustrated in a cross-sectional view. Power interface 117 includes connecting elements 28 suitable for mating alignment with connecting elements 30 in a second power interface integral with or coupled to vehicle interior element 24, 26. When light assembly 100 is secured to vehicle interior element 24, 26 via interfaces 18, 32, electrical contacts 34 and 36 are configured to pass electrical power from vehicle interior element 24, 26 to light assembly 100, and more specifically, to capacitor 115 or another rechargeable power source. Electrical contacts 36 may further be coupled to any vehicle power source, such as, the vehicle ignition power source, the vehicle battery, the vehicle alternator, or another vehicle-based power source. As a further alternative, interface 18 may be configured for coupling to a cigarette lighter of other courtesy power port to draw power therefrom. Accordingly, in this advantageous embodiment, light assembly 100 recharges capacitor 115 in a quick and efficient manner while coupled to vehicle interior element 24, 26. In an embodiment wherein light 10 is used as a courtesy light, a third electrical contact 36 (not shown) may be provided at interface 32 with a corresponding third electrical contact 34 at interface 18. The third electrical contact carries power in response to the open or closed state of a vehicle door.

Referring now to FIG. 6, light assembly 100 may also be charged in a wall-mounted household power outlet. Advantageously, a wall-mountable interface circuit 38 having a flashlight interface portion 40 and a wall-mounted power outlet interface portion 42 is provided. Wall-mountable interface 38 includes an AC-to-DC power converter to convert standard wall power to a DC power suitable for rechargeable light 10. Light assembly 100 is charged from a common household power outlet 44 in the wall 46 of a house, office, or other building. Wall-mountable interface circuit 38 may be integrally molded with light assembly 100 or separable therefrom. In this exemplary embodiment, light assembly 100 may be used for multiple functions including an automotive interior light, a household night light, and a flashlight. Further, light assembly 100 may include one or more light sources for each of these functions. A further function of light assembly 100 could be for use as an emergency flashing light which utilizes one or several light sources, which may be red, orange, or yellow and may provide a higher intensity light than the flashlight or night light functions.

Referring now to FIG. 7 and FIG. 8, these figures illustrate a perspective view of a light assembly 10 according to another exemplary embodiment. Body 12 of this embodiment may include one or more auxiliary non-light source functional units (not shown). Body 12 includes several features which assist a user in gripping and operating rechargeable flashlight 10. As illustrated in FIG. 7, body 12 includes a grip 48 including a recess and several parallel ribs within the recess, the recess having a size approximately that of a finger. Grip 48 is configured to allow the user to grip a bottom portion 66 of body 12. A second, larger grip 50 includes a plurality of horizontal bumps protruding outward from an outer surface of body 12 having a total area approximately that of several fingers of a user to allow the user to grab an upper portion 60 of body 12.

In this exemplary embodiment, light assembly 10 includes a plurality of light sources, one aimed in an upward direction and one aimed out of the side 52 of light assembly 10. Alternatively, a single light source may be used to provide light through a first lens 54 at a top 56 of light assembly 10 and a second lens 58 on side 52. In this embodiment, lens 54 directs light from the light source (not shown) in a conical or a torch-shaped fashion typical of a standard flashlight. Lens 58 scatters light from the light source to provide scattered light to an area, such as the interior of a vehicle, in a manner similar to a dome light of a vehicle. Numerous other configurations of lenses and light sources are contemplated.

FIG. 7 illustrates light assembly 10 in a first position, wherein lens 58 is exposed, and wherein a top portion 60 of body 12 is slid upward (as indicated by arrow 62) in a telescoping fashion over a middle portion 64 of body 12 to an interference. A user fit may effectuate this movement to the first position by gripping a bottom portion 66 of body 12, preferably using grip 48, and then sliding top portion 60 upward, preferably using grip 50. Portion 60 includes a locking mechanism (e.g., an interference fit) suitable for locking portion 60 into place in the first position. As illustrated in FIG. 8, the user may again slide top portion 60 back toward bottom portion 66 to place rechargeable flashlight 10 in the second position.

According to one embodiment, light assembly 10 may be in the first position wherein light is provided only through lens 58, while light assembly 10 is mounted to vehicle interior element 24, 26, and light assembly 10 is placed in the second position, in which light is provided only through lens 54 when the user removes the rechargeable flashlight from the vehicle interior element in order to use rechargeable flashlight as a portable light source. Switch 68 is operable in ON, OFF, or DOOR positions, as discussed hereinabove with reference to switches 22 and 23 in FIG. 1.

Referring now to FIG. 9, a cross-sectional view of light assembly 10 is illustrated having a mounting arrangement 140. Mounting arrangement 140 is configured to couple a light-emitting diode 142 to body 12. Mounting arrangement 140 is further configured to position light-emitting diode 142 in a first position 143 to direct light in a first direction and in a second position 145 to direct light in a second direction different than the first direction. In this exemplary embodiment, the first and second directions are separated by approximately 90 degrees. In alternative embodiments, the different directions may be more or less than 90 degrees. The transmission of light from light emitting diode 142 is in a generally conical pattern extending outward from the light source. This is unlike a light bulb where light generally projects in all directions from the light source. Accordingly, mounting arrangement 140 advantageously directs light through the first lens 54 or second lens 58, depending upon the desired usage of the rechargeable flashlight.

In this exemplary embodiment, mounting arrangement 140 includes a bar actuatable in response to movement of top portion 60 (see FIG. 7) in the direction of arrow 62. Bar 148 is rotatably coupled at first pivot 150 to body 144 of light emitting diode 142. A second pivot 152 extends from body 144 and is slidable within a track 154 of a bracket 156, bracket 156 being coupled to body 12. Bar 148 includes an L-shape at pivot 150.

In operation, when light assembly 100 is in a first position as illustrated in FIG. 7, bar 148 is in its lower most position wherein light-emitting diode 142 provides light through lens 58. As a user moves upper portion 60 of body 12 (see FIG. 7 and FIG. 8) over middle portion 64 toward bottom portion 66, body 12 exerts a force on bar 148 to move bar 148 upward. Bar 148 carries light-emitting diode 142 upward, guided by protuberance 152 within track 154. As protuberance 152 approaches an uppermost position, the L-shape of bar 148 rotates light-emitting diode 142 approximately 90 degrees to a position in which light-emitting diode 142 provides light through lens 54. The L-shape of bar 148 provides a locking mechanism to hold light-emitting diode 142 in position. This locked position can be overcome by providing a force on upper portion 60 in a direction away from bottom portion 66 to return light-emitting diode 142 to its first, lower position. While an exemplary mounting arrangement has been described in detail, alternative mounting arrangements configured to perform the stated functions are contemplated.

Referring now to FIGS. 10-13, an alternative embodiment 200 of a light assembly is illustrated, in which the auxiliary functional unit is a taser. In this exemplary embodiment, a pair of electrical contacts 160 serve a dual function of taser points and also as a power interface to receive power from a power source external to body 212 of light assembly 200. Although not illustrated in FIGS. 10 and 11, light assembly 200 includes a lighting assembly similar to that disclosed with reference to FIG. 7 and FIG. 8.

Body 212 includes a top portion 162, a middle portion 164, and a bottom portion 166. Top portion 162 includes recesses 168 for housing electrical contacts 160. Top portion 162 is slidable over middle portion 164 in a telescoping arrangement between first and second positions. FIG. 10 illustrates the first position of top portion 162, and FIG. 11 illustrates the second position of top portion 162. In the second position, electrical contacts 160 protrude from top portion 162. In the second position, light assembly 200 can be recharged through electrical contacts 160 or electrical contacts 160 can be brought in contact with an assailant to provide a charge to the assailant. Light assembly 100 further includes an ON/OFF switch 170 configured to turn a light source on or off.

Alternatively, upper portion 162 may be spring loaded and biased in the first position and switch 170 can enable current to flow through contacts 160 into an assailant. A user of this alternative embodiment must simply bring top portion 162 into contact with an assailant and press body 212 toward the assailant to expose contacts 160, and then actuate switch 170 to provide the desired charge.

Referring now to FIG. 12 and 13, another alternative light assembly is illustrated as light assembly 300. In this embodiment, a pair of electrical contacts 172 are small, coin-shaped contacts resting on an outer surface 174 of body 312. In this embodiment, contacts 172 do not retract within body 312. Contacts 172 may be used for both charging a capacitor (not shown) and for discharging the capacitor into an assailant. A taser switch 176 is illustrated as an operator-actuatable switch configured to enable current through contacts 172. A light enable switch 178 is further illustrated as an operator-actuable switch configured to enable and disable a light source within body 12. Alternative configurations are contemplated.

According to one exemplary embodiment, the capacitor or other power source in light assemblies 200 and 300 of FIGS. 10-13 is configured to discharge upon sensing contact with an assailant, such that an operator-actuated switch is not required to provide the discharge. According to another exemplary configuration, the power provided through the electrical contacts is configured to increase with each subsequent discharge of the capacitor. Thus, the capacitor or other power source need not discharge all its power with a single application of the taser.

While the exemplary embodiments illustrated in the Figures and described above are presently preferred, it should be understood that these embodiments are offered by way of example only. Each of the various embodiments disclosed herein may include portions of the other embodiments to provide numerous permutations of improved functionality. Further, various other functional units may be incorporated into the disclosed light assemblies 10, 100, 200, and 300. Accordingly, the present invention is not limited to a particular embodiment, but extends to various modifications that nevertheless fall within the scope of the appended claims.

What is claimed is:

1. A vehicle-mountable light assembly comprising:
a body configured to be mounted to a vehicle interior;
a power source;
a light source coupled to the power source and the body and configured to provide sustained light; and
an auxiliary, non-light source, functional unit.

2. The vehicle-mountable light assembly of claim 1, wherein the auxiliary, non-light source, functional unit is a mechanical system which does not require electrical power.

3. The vehicle-mountable light assembly of claim 2, wherein the auxiliary, non-light source, functional unit is selected from the group consisting of a bin for holding items and an instruction panel.

4. The vehicle-mountable light assembly of claim 3, wherein the instruction panel includes spare tire changing instructions.

5. The vehicle-mountable light assembly of claim 1, wherein the auxiliary, non-light source, functional unit is an electrical system configured to be powered by the power source.

6. The vehicle-mountable light assembly of claim 5, wherein the power source is a capacitor having at least 10 Farads.

7. The vehicle-mountable light assembly of claim 5, wherein the auxiliary, non-light source, functional unit is an emergency system.

8. The vehicle-mountable light assembly of claim 7, wherein the auxiliary, non-light source, functional unit is selected from the group consisting of a taser, a radio tuned to an emergency warning transmission, an audio system configured to provide emergency instructions, and a location signal transmitter circuit.

9. The vehicle-mountable light assembly of claim 5, wherein the auxiliary, non-light source, functional unit is a convenience system.

10. The vehicle-mountable light assembly of claim 9, wherein the auxiliary, non-light source, functional unit is selected from the group consisting of a radio, cassette player, CD player, and a location signal transmitter circuit.

11. The vehicle-mountable light assembly of claim 9, wherein the auxiliary, non-light source, functional unit is selected from the group consisting of a two-way radio transmitter, a wireless telephone charger, a clock, a compass, or a voice record/playback circuit.

12. The vehicle-mountable light assembly of claim 1, wherein the power source is a capacitor having at least 10 Farads.

13. The vehicle-mountable light assembly of claim 12, further comprising a power interface configured to be coupled to a power source external to the body and to provide power to charge the capacitor.

14. The vehicle-mountable light assembly of claim 13, wherein the power interface is configured to receive power from a vehicle power source.

15. The vehicle-mountable light assembly of claim 1, wherein the light source includes a light emitting diode.

16. The vehicle-mountable light assembly of claim 1, further comprising a second light source coupled to the power source, the second light source configured to provide a flashing light.

17. The vehicle-mountable light assembly of claim 1, further comprising a second auxiliary, non-light source, functional unit coupled to the body.

18. The vehicle-mountable light assembly of claim 17, wherein the auxiliary, non-light source, functional unit is an electrical functional unit and wherein the second auxiliary, non-light source, functional unit is a mechanical functional unit.

19. A multi-functional light source for a vehicle comprising:
a body configured to be mounted to a vehicle interior, the body comprising an interface circuit configured to receive power from the vehicle;
a power source coupled to the interface circuit and configured to receive the vehicle power;
a light source coupled to the power source; and
a means for providing an auxiliary function other than sourcing light.

20. The multi-functional light source of claim 19, wherein the means for providing an auxiliary function is a mechanical system which does not require electrical power.

21. The multi-functional light source of claim 19, wherein the means for providing an auxiliary function is an electrical system configured to be powered by the power source.

22. The multi-functional light source of claim 21, wherein the power source is a capacitor having at least 10 Farads.

23. The multi-functional light source of claim 21, wherein the means for providing an auxiliary function is an emergency system.

24. The multi-functional light source of claim 21, wherein the means for providing an auxiliary function is a convenience system.

25. The multi-functional light source of claim 19, further comprising a power interface configured to be coupled to a power source external to the body and to provide power to charge the capacitor.

26. The multi-functional light source of claim 19, further comprising a second means for providing an auxiliary function other than sourcing light.

27. The multi-functional light source of claim 26, wherein the means for providing an auxiliary function is an electrical means and the second means for providing an auxiliary function is a mechanical means.

28. A flashlight, comprising:
a body;
a light-emitting diode; and
a mounting arrangement configured to couple the light-emitting diode to the body, wherein the mounting arrangement is configured to position the light-emitting diode in a first position to direct light in a first direction and to position the light-emitting diode in a second direction to direct light in a second direction different than the first direction.

29. The flashlight of claim 28, further comprising a capacitor configured to provide power to the light-emitting diode.

30. The flashlight of claim 28, wherein the first direction and second direction are separated by approximately 90 degrees.

31. The flashlight of claim 28, wherein the body is configured to be mounted to a vehicle interior element.
